(19) United States
(12) Patent Application Publication
(10) Pub. No.: US 2014/0283143 A1
(43) Pub. Date: Sep. 18, 2014

(54) SOFTWARE APPLICATION FOR MANAGING PRODUCT MANUALS

(71) Applicant: Harnischfeger Technologies, Inc., Wilmington, DE (US)

(72) Inventors: Lee Griffin, Oak Creek, WI (US); Paul Blankenheim, Colgate, WI (US); Eric Esser, Hales Corners, WI (US)

(21) Appl. No.: 14/206,332

(22) Filed: Mar. 12, 2014

Related U.S. Application Data
(60) Provisional application No. 61/777,137, filed on Mar. 12, 2013.

(51) Int. Cl. G06F 21/64

(52) U.S. Cl. CPC G06F 21/64
USPC 726/30

(57) ABSTRACT

Methods, systems, and computer-readable medium for managing product manuals. One system includes an electronic device that is configured to download a product manual from a server, store the product manual to non-transitory computer-readable medium included in the electronic device, and associate an authentication period with the product manual. The electronic device is also configured to receive a request to display the product manual from a user and, in response to the request, display the product manual to the user when the authentication period has not expired. In addition, the electronic device is configured to automatically delete product manual from the non-transitory computer-readable medium when the authentication period has expired.

### RELATED APPLICATIONS

This application claims priority to U.S. Provisional Patent Application No. 61/777,137 filed Mar. 12, 2013, the entire content of which is hereby incorporated by reference.

### FIELD

Embodiments of the present invention relate to systems and methods for managing and keeping product manuals up-to-date.

### BACKGROUND

Manuals provide important information for operating or using various types of products (e.g., devices, systems, services, etc.). For example, users of industrial machinery, such as mining machinery, use manuals to ensure efficient and safe machine operation, maintenance, training, etc. These manuals, however, can quickly become outdated, and it is difficult to provide updates to users located throughout the world. In addition, there are sufficient costs associated with distributing completely new manuals to user every time there is an update. Furthermore, even if individual updates are successfully distributed to users, it becomes burdensome for a user to reference the original manual, the new update, and any previous updates. Accordingly, users may ignore updates. Manuals and associated updates also differ between different types or models of machinery. Accordingly, users need to be provided with the specific manuals and corresponding updates for the machinery they own or operate, which further complicates the manual distribution and update process.

### SUMMARY

Therefore, embodiments of the invention provide methods and systems for managing product manuals. In some embodiments, users use a manual management application installed on a smart phone, tablet computer, or other electronic device that allows the user to access a product manual stored locally on the electronic device or available for download over a network from a server. In some embodiments, manuals accessible through the application (locally or via the server) are automatically filtered to only include manuals associated with products owned or operated by the user.

In particular, the manual management application allows a user to access a current version of a product manual from a server over a network. The application allows the user to download the manual and, thereafter, access the manual even when the application is not connected to the server or a network. In some embodiments, the user is required to authenticate the application with the server within a predetermined time period (e.g., days, weeks, months, etc.). Authenticating the application with the server includes accessing the server and receiving the most current version of any manuals previously-downloaded by the application. If the user does not authenticate the application with the predetermined time period, the application prevents the user from accessing previously-downloaded manuals (e.g., the application deletes the previously-downloaded manuals) to prevent the user from using potentially outdated information.

For example, one embodiment of the invention provides a method of managing product manuals. The method includes downloading, by a processing unit, a product manual over at least one network, storing, by the processing unit, the product manual to non-transitory computer-readable medium, and associating, by the processing unit, an authentication period with the product manual. The method also includes receiving, by the processing unit, a request to display the product manual from a user and, in response to the request, displaying, by the processing unit, the product manual to the user when the authentication period has not expired. In addition, the method includes automatically deleting, by the processing unit, the product manual from the non-transitory computer-readable medium when the authentication period has expired.

Another embodiment of the invention provides a system for managing product manuals. The system includes an electronic device that is configured to download a product manual from a server, store the product manual to non-transitory computer-readable medium included in the electronic device, and associate an authentication period with the product manual. The electronic device is also configured to receive a request to display the product manual from a user and, in response to the request, display the product manual to the user when the authentication period has not expired. In addition, the electronic device is configured to automatically delete the product manual from the non-transitory computer-readable medium when the authentication period has expired.

Yet another embodiment of the invention provides non-transitory computer-readable medium. The medium contains executable instructions for downloading a product manual over at least one network, storing the product manual to non-transitory computer-readable medium, and associating an authentication period with the product manual. The medium also stores instructions for receiving a request to display the product manual from a user, displaying the product manual to the user when the authentication period has not expired, and automatically deleting the product manual from the non-transitory computer-readable medium when the authentication period has expired.

Other aspects of the invention will become apparent by consideration of the detailed description and accompanying drawings.

### BRIEF DESCRIPTION OF THE DRAWINGS

FIGS. 1a-c schematically illustrate a system for accessing product manuals.

FIG. 2 is a flow chart illustrating a manual management method performed by the system of FIGS. 1a-c.

FIGS. 3-11 are screen shots displayed as part of the method of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. Also, electronic communications and notifications may be performed using any known means including direct connections, wireless connections, etc. It should also be noted that a plurality of hardware- and software-based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processing units. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible. For example, “electronic devices,” “computers,” “computing devices,” “controllers,” “control devices,” or “control modules” described in the present specification can include standard processing components, such as one or more processing units, one or more computer-readable medium modules, one or more input/output interfaces, and various connections (e.g., a system bus) connecting the components.

FIG. 1a illustrates a system 100 for managing product manuals. The system 100 includes an electronic device 200 operated by a user that communicates with a server 300 over a network 310 (i.e., the server 300 is remote from the electronic device 200). The term “user” as used in the present document includes any individual associated with a product that uses the electronic device 200 to access a manual for the product. Within the mining industry, a user can include a mine owner, a mine employee, a product owner (e.g., an employee or sales representative of the machine manufacturer, owner, distributor, etc.), and other individuals associated with particular mining machinery or related services. Similarly, the term “product” used in the present document includes devices, systems, and services (e.g., software services and tools).

The network 310 can include a cellular network, the Internet, a wide-area-network (“WAN”), and/or local-area-network (“LAN”). The network 310 can be constructed from one or more wired and/or wireless connections. It should be understood that multiple users can use an electronic device 200 to communicate with the server 300 over the network 310 (see, e.g., FIG. 1b) or other networks. Also, an electronic device 200 operated by a particular user may differ from other users. For example, one user may use an electronic device 200 that includes a smart phone and another user may use an electronic device 200 that includes a laptop or tablet computer. Furthermore, in some embodiments, multiple servers 300 are used to store and distribute manuals.

The electronic device 200 can include a smart phone, a tablet computer, a laptop computer, a desktop computer, a smart television, a kiosk, a smart watch, or a similar device capable of communicating with the server 300. For example, as illustrated in FIG. 1a, the electronic device 200 can include a tablet computer that includes a touchscreen 200a. In some embodiments, the electronic device 200 can also communicate with one or more peripheral devices 200b, such as a keyboard, a mouse, a printer, a projector, etc. The electronic device 200 can communicate with the peripheral devices 200b using a wired or wireless connection (e.g., Bluetooth).

As illustrated in FIG. 1c, the electronic device 200 includes a processing unit 250 (e.g., a processor, an applications-specific integrated circuit (“ASIC”), etc.), non-transitory computer-readable medium 255, and an input/output interface 260. It should be understood that in other constructions the electronic device 200 includes additional, fewer, or different components.

The processing unit 250 is configured to retrieve instructions and data from the medium 255 and execute, among other things, the instructions. The input/output interface 260 transmits data from the processing unit 250 to external systems, networks, and/or devices and receives data from external systems, networks, and/or devices. In particular, the input/output interface 260 communicates with the server 300 over the network 310. The input/output interface 260 can also communicate with any peripheral devices 200b used with the electronic device 200. The input/output interface 260 can also store data received from external sources to the medium 255 and/or provide the data to the processing unit 250.

The computer-readable medium 255 stores program instructions and data including a manual management application (or “application”) 265 for accessing product manuals. The medium 255 also stores downloaded manuals and, optionally, user settings. In some embodiments, the application 265 is a mobile application specifically programmed for mobile electronic devices 200, such as smart phones and tablet computers (e.g., devices operating on the iOS, Android, or Windows operating system or platform). As described in more detail below, the application 265 can be configured to communicate with the server 300 (e.g., through an application interface “API”) to retrieve product manuals.

As illustrated in FIG. 1c, the server 300 includes a processing unit 350 (e.g., a processor, an ASIC, etc.), non-transitory computer-readable medium 355, and an input/output interface 360. It should be understood that in other constructions, the server 300 includes additional, fewer, or different components. Also, in some embodiments, the system 100 includes multiple servers 300.

The processing unit 350 is configured to retrieve instructions and data from the medium 355 and execute, among other things, the instructions. The input/output interface 360 transmits data from the processing unit 350 to external systems, networks, and/or devices and receives data from external systems, networks, and/or devices. In particular, the input/output interface 360 communicates with the electronic device 200 over the network 310. The input/output interface 360 can also store data received from external sources to the medium 355 and/or provide the data to the processing unit 350.

The computer-readable medium 355 stores program instructions and data for managing product manuals. In particular, the medium 355 stores instructions for exchanging information with the manual management application 265 executed by an electronic device 200.

The medium 355 also stores product manuals. As used in the present document, the terms “product manuals,” “manuals,” and “updates” includes user manuals, maintenance manuals, training manuals, troubleshooting manuals, and other technical documentation regarding a particular product (e.g., technical drawings or specifications). These terms can also include other information associated with a particular product, such as provider information (e.g., contact information or sale representative information), product offerings and related services (e.g., repair services), information regarding related products (e.g., replacement parts, etc.), etc. Each manual can be associated with metadata, which is also stored on the server 300. The metadata can map a manual to a particular product, a particular model, a particular version, a particular language, a particular geographic location, etc. In some embodiments, the server 300 is configured to generate portions of the metadata. For example, the server 300 can be configured to assign a unique serial number to each manual. In other embodiments, an administrator specifies all or portions of the metadata when uploading a manual to the server 300. In some embodiments, when a manual is downloaded to an electronic device 200, the associated metadata (or a portion thereof) is also downloaded and stored on the device 200.

The medium 355 can also store user settings. The user settings identify a particular authorized user of the manual management application 265 (e.g., by username or another unique identifier) and specify user preferences, such as language, geographic location, etc. The user settings can also track a particular user's use of the manual management application 265 (e.g., past manuals accessed and/or downloaded). The user settings can also map a user to one or more products (e.g., products owned or operated by the user). For example, within the mining industry, the user settings can map users to particular mines and particular mining products used within a particular mine. The user settings can also map a user to a particular user category that defines the user's rights within the application 265. As described below in more detail, the server 300 and/or the electronic device 200 can use the metadata and the user settings to automatically provide a user with filtered or tailored information (e.g., manuals for products operated by the user in the user's preferred language). For example, the server 300 and/or the electronic device 200 can automatically match user settings to manual metadata to identify what manuals should be made available to a particular user.

Some or all of the user settings can also be stored on the electronic device 200 (e.g., downloaded from the server 300). For example, the device 200 can obtain user settings from the server 300 during device authentication (described below). The user settings can provide information regarding authorized users, products associated with particular users, etc. The application 265 can use the received user settings to control access to the application 265. For example, the application 265 can use the settings to determine what users are currently authorized to login and use the application 265. Also, if the device 200 receives updated user settings that specify that a user is associated with fewer or different products than before, the device 200 can be configured to automatically delete any previously-downloaded manuals for the user that the user should no longer have access to. Similarly, a device 200 can receive updated user settings that particular manuals should no longer be used by one or more users and, therefore, the application 265 can automatically delete these manuals. In some embodiments, the application 265 is also configured to update user settings automatically and/or based on data received from users (e.g., provide usage information for particular manuals, provided updated user settings based on data received through a settings screen 449 (described below), etc.). If the application 265 has any updated user settings, the application 265 can transmit the updates to the server 300 (e.g., during device authentication).

FIG. 2 is a flow chart illustrating a method 400 of managing product manuals performed by the system 100. Although portions of the method 400 are described as being performed by the electronic device 200, it should be understood that the device 200 is configured to perform the functionality described below through executing the manual management application 265 using the processing unit 250.

To use the application 265, a user logs in by providing credentials (at block 401). For example, FIG. 3 illustrates a login screen 402. As illustrated in FIG. 3, the login screen 402 includes one or more credential input mechanisms 402a that allow a user to input credentials (e.g., a username and a password). In some embodiments, if the user forgets their credentials, the user can select a “Forgot your password?” link 402b on the login screen 401. Clicking the link 402b can take the user to another screen where he or she can answer one or more security questions to verify their identity. The security questions and answers can be selected by the user and can be stored on the electronic device 200 and/or the server 300. If the user's identity is verified, the user can reset his or her credentials. After the user enters his or her credentials, the user can select a “Sign In” selection mechanism 402c.

The application 265 uses the credentials to verify the user (at block 403). When the electronic device 200 is connected to the network 310, the application 265 can be configured to provide the received credentials to the server 300 for verification. In other embodiments, the application 265 accesses data (e.g., user settings) stored in the medium 255 to verify the user. As described above, the stored information can be periodically updated based on data received from the server 300.

If the user is not verified (at block 403), the application 265 prevents the user from accessing any manuals through the application 265 (or using the application 265 in any form) (at block 404). Accordingly, regardless of who is using the electronic device 200, only authorized users can access product manuals through the manual management application 265.

If a user is verified (at block 403), the application 265 determines whether the user's authentication period has expired (at block 405). The authentication period is a predetermined period of time (e.g., minutes, hours, days, weeks, months, etc.) that designates how often the user should connect with the server 300. As described below, in some embodiments, the authentication period is associated with a user (or the electronic device 200 used by the user) such that all downloaded manuals are associated with the same authentication period. In other embodiments, an individual manual can be associated with a specific authentication period (which may different between downloaded manuals). For example, when a user downloads a manual, the application 265 can set or track an authentication period for the manual (e.g., 30 days). The authentication period can run from the date of the most recent authentication with the server 300, the date of download of a manual, the issue or publication date of a manual, etc. It should be understood that the authentication period can be tracked by counting up from zero to the predetermined period of time or counting down from the predetermined period of time to zero.

When the authentication period has not expired (at block 405), the application 265 displays a list of manuals available through the application 265 (at block 406). The list of manuals includes manuals previously downloaded to the electronic device 200 from the server 300. Accordingly, unless the authentication period has expired, a user can access previously-downloaded manuals even when the electronic device 200 is not connected to the network 310 or the server 300. This functionality is particularly important in many industries where electronic devices 200 are operated in areas with limited or no network access, such as construction sites and underground mines.

In some embodiments, if a connection to the server 300 is available, the list of available manuals also included manuals stored on the server 300 that are available for download to the electronic device 200. In some embodiments, manuals that are available for download are displayed differently than previously-downloaded manuals. As noted above, the server 300 and/or the application 265 can use the user settings and the manual metadata to automatically identify manuals for a particular user. For example, the server 300 can use the stored user settings and manual metadata to determine what manuals to make available for download (e.g., manuals for products operated by or otherwise associated with the user in the user's preferred language). In some embodiments, the application 265 is configured to automatically download all manuals authorized for or made available to a user. In other embodiments, the application 265 is configured to display a list of available manuals and allow a user to select which manuals to download. Allowing a user to select manuals for downloading decreases bandwidth requirements and lowers memory requirements.

If an available manual is selected for downloaded (e.g., by the user or set for automatic download), the application 265 downloads the manual and stores the manual on the electronic device 200 (i.e., in the medium 255). In some embodiments, when the application 265 downloads a manual from the server 300, the application 265 encrypts the manual before storing the manual on the electronic device 200. In these configurations, the manual management application 265 is configured to decrypt the manuals or otherwise provide secure access to the manuals. The encryption/decryption process used by the application 265 is inaccessible to users of the application 265. Accordingly, the downloaded manuals can only be accessed through the application 265, which can only be used by authorized users (e.g., users providing a valid username and password). Therefore, the application 265 helps ensure security and prevents misappropriation of manuals that may include confidential, trade secret, or other proprietary or sensitive information. It should be understood that in some embodiments, the application 265 receives manuals from the server 300 in an encrypted form.

FIGS. 4a and 4b illustrate a manual selection screen 407 that displays a list of available manuals. As illustrated in FIGS. 4a and 4b, the list of available manuals can be displayed graphically (e.g., each manual is associated with a selectable icon 407a). In other embodiments, available manuals can be displayed as a text-based list. In some embodiments, the available manuals are categorized and/or grouped. For example, as illustrated in FIG. 4a, manuals associated with a particular product (e.g., the 4100XPC Centurion product provided by Joy Global) can be grouped or displayed together. A label 407b included on the manual selection screen 407 specifies the product associated with the displayed manuals. If multiple products are available, the manual selection screen 407 can include multiple selectable labels 407b, and a user can select one of the labels 407b to view the manuals associated with the selected product. The manual selection screen 407 can also include a back selection mechanism 407c that allows the user to return to the previous screen (e.g., a previous category). Alternatively or in addition, manuals can be grouped based on what portion of a product a manual relates to (e.g., a mechanical, electrical, or operator suite, product operation, product troubleshooting, product maintenance, etc.). As illustrated in FIG. 4b, when manuals are grouped, the icons 407a can indicate how many manuals are in a particular group. A grouping can also include a display button 407d that allows a user to see what manuals are included in the group and/or search for particular terms within the group.

To view or otherwise access one of the manuals included in the list of available manuals, a user can a select a manual (e.g., by clicking on one of the icons 407a) (at block 408), and the application 265 displays the selected manual to the user (at block 409). For example, FIG. 5 illustrates a manual display screen 410 that displays a page of a downloaded manual. In some embodiments, when a manual is displayed on the electronic device 200, the manual is displayed in a portable document file (“PDF”) format. As illustrated in FIG. 5, the screen 410 includes a menu selection mechanism 412. A user can select the menu selection mechanism 412 to access various functions for the currently-displayed page and/or manual. For example, manuals can be text-searchable, which allows the user to locate keywords or phrases within the manual. Therefore, a user can select the menu selection mechanism 412 to initiate a search on a displayed manual (e.g., by inputting one or more keywords and/or search terms). In response, the application 265 can generate a list of search results that displays relevant sections of the manual matching the search. The list of search results can be listed in page order and/or by relevancy, and a user can select a particular search result to jump to the associated section of the displayed manual. In some embodiments, manuals also include a table-of-contents that allows a user to select an item in the table-of-contents to automatically jump to the associated section of the manual. Accordingly, a user can quickly navigate through a selected manual to obtain needed information.

In some embodiments, a user can also add notes or other commentary to a selected manual (e.g., comments, highlighting, bookmarks, etc.) by selecting the menu selection mechanism 412. In addition, a user can select the menu selection mechanism 412 to provide feedback for the currently-displayed manual. For example, if a user identifies errors or other problems with a particular portion of a manual, the user can provide feedback identifying the errors or problems (or provide other comments or questions). As illustrated in FIG. 5, the user can provide the feedback in a note 414 (e.g., a separate window or object). The user can add text to the note 414 describing the feedback and, in some embodiments, can position the note 434 close to the portion of the manual that the feedback relates to. The note 414 is saved with the manual on the device 200. However, as illustrated in FIG. 5, a user can select a delete or cancel selection mechanism 416 to delete the note 414. Alternatively, a user can select a send selection mechanism 418 to have the feedback contained in the note 414 automatically transmitted to one or more parties responsible for creating and/or updating the manual. If the electronic device 200 is not currently connected to the network 310, the manual management application 265 can be configured to store the feedback and transmit the feedback the next time the electronic device 200 is connected to the network 310. As illustrated in FIG. 6, the application 265 can display a notification 420 to the user when feedback has been successfully transmitted.

When transmitting the feedback, the manual management application 265 associates the feedback with the manual and/or the particular section (e.g., page) of the manual and automatically transmits the feedback and associated data to the responsible party or parties (e.g., the manual creator or publisher) (e.g., via an email message). If the recipient of the feedback believes that an update is needed based on the feedback, the recipient can create a new version or an update to the manual (or initiate such an update). The new version or update can be stored and processed by the server 300 and will be made available to users as described above. In some embodiments, the application 265 transmits feedback to the server 300, and the server routes the feedback to the responsible parties.

In some embodiments, while a manual is displayed, the application 265 continues to check whether the authentication period has expired. If the period expires while a manual is being displayed, the application 265 can be configured to stop displaying the manual (e.g., and notify the user of the expiration). In other embodiments, the application 265 is configured to continue to allow the user to view and access the manual, but can notify the user of the expiration. In particular, the application 265 can be configured to only take action on an expired authentication period when the expiration is detected at log-in.

Also, as the authentication period nears expiration, the application 265 can be configured to notify the user of the upcoming expiration. For example, as illustrated in FIG. 7, the application 265 can generate a notification 422 that informs the user that authentication (also referred to as “re-authentication”) is required within the remaining portion of the authentication period (e.g., within the next three days). The notification 422 can include a textual alert or message, a graphical alert, an audible alert, a tactile alert (e.g., a vibration), or a combination thereof. In some embodiments, after issuing the alert, the application 265 prompts the user regarding whether the user wants to attempt device authentication. The application 265 can also be configured to alert the user of the authentication period any time the user uses the application 265 when the device 200 is not connected to the server 300. The alert can inform the user that authentication is encouraged (regardless of the status of the authentication period) to ensure that the user is accessing up-to-date information.

As illustrated in FIGS. 4a and 4b, the manual selection screen 407 (and other screens generated by the electronic device 200) can also include an update icon 430a, a refresh icon 430b, a favorites icon 430c, a settings icon 430d, and combinations thereof. As described below, a user can use these icons to perform functions with the application 265 other than viewing a downloaded manual. For example, the update icon 430a can include a number (e.g., “3”) that represents the current number of updates that are available for download. This number can be based on information provided by the server 300. For example, the electronic device 200 can connect to the server 300 and access information regarding new users, new user settings or preferences, new updates, etc. This data can be accessed during device authentication (described below) or separate from device authentication. In some embodiments, these notifications can be pushed to the electronic device 200 from the server 300. Alternatively, the number can be based on information stored by the device 200. If a user selects the update icon 430a, the application 265 can generate and display an update screen 438 as illustrated in FIG. 8. The update screen 438 includes a list of available updates 438a, and the user can select a particular update from the list 438a to download the update from the server 300 (i.e., assuming that a connection to the server 300 is currently available). In some embodiments, a user can also select an “update” selection mechanism 438b to download all available updates.

When a user selects the refresh icon 430b, the application 265 refreshes the list of available updates (e.g., updates the update icon 430a and/or the associated update screen 438) (assuming a connection to the server 300 is available). In some embodiments, the application 265 is configured to update the available updates automatically, but a user can use the refresh icon 430b to perform a manual update. If no updates are available when a user selects the refresh icon 430b, the application 265 can display an alert 440 that informs the user that no updates are available (see, e.g., FIG. 9).

Also, in some embodiments, when a user selects the refresh icon 430b, the application 265 is configured to update the list of available manuals. Therefore, depending on recent downloads or updates (or changes in user settings or preferences), selecting the refresh icon 430b can change the number of available manuals displayed by the device 200 and/or the configuration or grouping of available manuals.

Selecting the favorites icon 430c accesses a list of available manuals that the user previously set as “favorites.” For example, when viewing a particular manual, the user can select the favorites icon 430c (e.g., through the menu selection mechanism 412) to set the currently-displayed manual as a “favorite.” Accordingly, the user can use the favorites icon 430c to quickly access those manuals that the user frequently uses.

The settings icon 430d allows the user to access his or her settings or preferences for the application 265. For example, FIG. 10 illustrates a settings screen 449 displayed by the application 265 when the user selects the settings icon 430d. A user can use the settings screen 449 to view his or her login history and device authentication history (e.g., the authentication period). A user can also use the settings screen 449 to view his or her credentials and, in some embodiments, change the credentials (e.g., change username, password, security questions, etc.). As illustrated in FIG. 10, in some embodiments, the user can also use the settings screen 449 to initiate device authentication. For example, in some embodiments, the settings screen 449 also includes a “Renew Access” selection mechanism 449a. Selecting the “Renew Access” selection mechanism 449a manually initiates device authentication.

In particular, if a user selects the “Renew Access” selection mechanism 449a (at block 450, FIG. 2), the application 265 attempts to connect to the server (at block 452). If the network 310 is not available or the device 200 cannot otherwise connect to the server 300, the application 265 informs the user that device authentication cannot be performed and the user should try again later. In some embodiments, the application 265 is configured to attempt connection with the server 300 for a predetermined period of time or a predetermined number of times before informing the user that device authentication is not available.

If a connection with the server 300 is established (at block 452), the application 265 perform device authentication by downloading updated manuals to the electronic device 200 (at block 454). In some embodiments, the application 265 automatically downloads a new copy of every manual previously-downloaded to the device 200. In other embodiments, application 265 determines which manuals (of those previously-downloaded) have updates available. For example, the application 265 can be configured to compare issue or publication dates of manuals available through the server 300 with issue or publication dates of manuals previously-downloaded. It should be understood that when downloading an update to a manual, the application 265 can download an updated version of the entire manual or an update (e.g., an appendix or other insertion) to a previously-downloaded manual. When an updated version of an entire manual is downloaded, the application 265 can be configured to automatically delete the previously-downloaded version of the manual (if it hadn't already been deleted as described below).

During device authentication, the application 265 also resets the authentication period (at block 456). As noted above, the authentication period can be associated with the device 200 and/or a particular user of the device 200. Therefore, the authentication period can be associated with all downloaded manuals. In other embodiments, the authentication period can be set for individual manuals. Also, it should be understood that in some embodiments, rather than downloading an update during device authentication, the application 265 updates the authentication period (e.g., for the device 200 and/or for particular manuals). For example, if an update is not available for a particular manual or the server 300 otherwise indicates that the authentication period for a particular manual should be updated (e.g., reset, shortened, extended, etc.), the application 265 can reset the authentication period for the manual. It should be understood that in some embodiments, the server 300 also tracks the authentication period (e.g., based on information transmitted by the electronic device 200 or independently of the period tracked by the application 265).

After performing device authentication, the application 265 can return to displaying a list of available manuals (see FIGS. 4a and 4b). In some embodiments, the application 265 also prompts the user whether the connection to the server 300 should be ended (e.g., to conserve bandwidth or data charges). The application 265 can also be configured to display a notice that informs the user that device authentication is complete.

In some embodiments, selecting the “Renew Access” selection mechanism 449a is the only way to initiate device authentication. Accordingly, the user is forced to manually initiate a connection with the server 300. In other embodiments, however, the application 265 can be configured to automatically perform device authentication (in addition to or in place of allowing a user to manually initiate device authentication). For example, the application 265 can be configured to automatically attempt device authentication anytime a connection to the server 300 is available, on a predetermined schedule or frequency (e.g., every 15 days, the first Monday of each month, etc.), and/or when the authentication period expires or is about to expire (e.g., three days before expiration).

If device authentication is not performed before the authentication period expires (either manually or automatically), the application 265 takes one or more steps to force the user to connect to the service and prevent the user from accessing potentially updated or unauthorized materials. For example, as illustrated in FIG. 2, if a user logs into the application 265 (at block 403) and the application 265 determines that the authentication period has expired (at block 405), the application 265 alters the functionality of the application 265 to encourage the user to perform device authentication. For example, in some embodiments, if the authentication period has expired (at block 405), the application 265 allows the user to use the application 265 for a limited extension period (e.g., five days). The extension period can start from the first time the user accesses the application 265 after the authentication period has expired. For example, if the authentication period expires on Jan. 1, 2013 and the user first accesses the application 265 on Mar. 1, 2013, the application 265 allows the user to use the application 265 for approximately from Mar. 1, 2013 until Mar. 6, 2013 (e.g., when the extension period is five days). To continue to use the application 265, the user must perform device authentication during the extension period.

Accordingly, if the authentication period has expired (at block 405) and the user logs into the application 265 for the first time since the authentication period expired (at block 460), the application 265 sets the extension period (at block 462). The application 265 can also generate and display a warning informing the user that the user must perform device authentication within the extension period if the user wants to continue to use the application 265 (see, e.g., the warning 464 illustrated in FIG. 11). In some embodiments, the application 265 generates the warning 464 each time the user uses the application 265 within the extension period.

If the user fails to perform device authentication within the extension period (at block 466), the application 265 is configured to automatically block the user from accessing or using the application 265 and, consequently, accessing or using any manuals previously-downloaded through the application 265. In some embodiments, the application 265 is configured to automatically delete all of the manuals previously downloaded or accessed by the user from the electronic device 200 (at block 468). Therefore, the user is prevented from accessing potentially outdated or potentially unauthorized materials. It should be understood that the extension period is optional. Therefore, in some embodiments, the application 265 is configured to automatically delete all previously-accessed manuals stored on the electronic device 200 as soon as the authentication period expires.

When manuals are deleted due to the lack of a required device authentication, the application 265 can still be allowed to access the application 265. However, no manuals will be accessible through the application 265 until device authentication is performed. In other embodiments, when required device authentication is not performed, the user can be prevented from accessing or using the application 265. In these situations, the user may be required to contact a service provider associated with the application 265 and request that his or her access to the application 265 be reset. In some embodiments, a user (or the user's employer) can be charged for such resets to provide a further incentive to perform the required device authentications.

In some embodiments, to manage users, user settings, manuals, and manual metadata, the system 100 includes an administration tool. The administration tool can be provided as a website (e.g., hosted by the server 300 or a separate server) accessible by an administrator using a browser application (e.g., Microsoft Internal Explorer, Mozilla Firefox, Google Chrome, or Apple Safari) executed by an electronic device 200. In other embodiments, the administration tool is a locally-stored application executed by an electronic device 200 (e.g., included in or separate from the manual management application 265). An administrator can use the administration tool to create, update, and delete users, user settings, manuals, and manual metadata. In some embodiments, the administration tool also provides a separate tool, such as a file transfer protocol (“FTP”) website, that allows for bulk importing of information (e.g., manuals, users, etc.) to the server 300.

In some embodiments, different categories of administrators can be allowed to use the administration tool and each category can be associated with different levels of rights (e.g., access rights, modification rights, etc.). Similarly, users of the manual management application 265 can be assigned to different categories of users that have different levels of rights. For example, within the mining industry, sales representatives may be given access to all manuals available through the server 300, mine owners or operators may be given access to all manuals associated with all products in all of the owner's or operator's mines, and mine employees may be given access to all manuals associated with all products for the mine(s) where the employee works.

It should be understood that the server 300 can include multiple servers. For example, in some embodiments, one server can be used to store manuals available for download and another server can store information regarding available manuals and/or users (e.g., manual metadata, user settings, manual availability, update availability, etc.). Accordingly, the application 265 can be configured to access the first server to download manuals and can be configured to access the second server to obtain information about user settings, available manuals (e.g., available updates, for use with the update icon 430a and/or the refresh icon 430b), etc.

It should also be understood that in some embodiments, the application 265 is also configured to provide access to a manual stored on the server 300 without downloading a copy of the manual to the device 200. For example, in some embodiments, the application 265 allows users to access all or a portion of available manuals when the device 200 is connected to the server 300 rather than or as a prelude to downloading the manual. A user can use this feature to preview a product manual before downloading or quickly access a portion of manual that the user may access infrequently (and, therefore, may not want to use bandwidth or memory to download the entire manual). Similarly, in some embodiments, a user can specify whether to download a complete version of a manual or only a portion.

Therefore, embodiments of the invention provide systems and methods for managing product manuals. In particular, the methods and systems provide a central repository for manuals that users can quickly access on-demand when they are connected to a network and a local repository for manuals that users can access on-demand when they are not connected to a network. The systems and methods also filter manuals made available to a particular user to ensure that each user is accessing the correct manuals. The systems and methods also allow user to provide feedback on manuals. In addition, the systems and methods provide information security and ensure that authorized users use up-to-date manuals.

Various features and aspects of the invention are set forth in the following claims.

What is claimed is:

1. A method of managing product manuals, the method comprising:
downloading, by a processing unit, a product manual over at least one network;
storing, by the processing unit, the product manual to non-transitory computer-readable medium;
associating, by the processing unit, an authentication period with the product manual;
receiving, by the processing unit, a request to display the product manual from a user;
in response to the request, displaying, by the processing unit, the product manual to the user when the authentication period has not expired; and
automatically deleting, by the processing unit, the product manual from the non-transitory computer-readable medium when the authentication period has expired.

2. The method of claim 1, wherein associating the authentication period with the product manual include associated the same authentication period with each product manual downloaded to the computer-readable medium.

3. The method of claim 1, further comprising displaying an alert to the user when the authentication period has expired.

4. The method of claim 1, further comprising displaying an alert to the user when the authentication period will expire within a predetermined amount of time.

5. The method of claim 1, wherein automatically deleting the product manual includes
setting an extension period after the authentication period has expired, the extension period running from a first verification of user credentials after the authentication period has expired to a predetermined period of time after the first verification; and
automatically deleting the product manual from the non-transitory computer-readable medium when no request to perform device authentication from the user is received during the extension period.

6. The method of claim 1, further comprising:
receiving a request to perform device authentication from the user before the authentication period expires;
in response to the request to perform device authentication, connecting to at least one server over at least one network;
downloading an updated version of the product manual from the at least one server; and
resetting the authentication period.

7. The method of claim 1, further comprising receiving feedback from the user associated with at least one portion of the product manual and automatically transmitting the feedback to a responsible party for the product manual.

8. The method of claim 1, further comprising automatically identifying a plurality of product manuals available for download, wherein the plurality of product manuals are selected based on settings associated with the user and metadata associated with each of the plurality of manuals available for download.

9. The method of claim 8, wherein downloading the product manual includes receiving a selection of one of the plurality of product manuals available for download and downloading the one of the plurality of manuals.

10. The method of claim 1, wherein downloading the product manual includes automatically downloading the product manual in a predetermined language based on user settings associated with the user.

11. A system for managing product manuals, the system comprising:
a device configured to
download a product manual from a server,
store the product manual to non-transitory computer-readable medium included in the device,
associate an authentication period with the product manual,
receive a request to display the product manual from a user,
in response to the request, display the product manual to the user when the authentication period has not expired, and
automatically delete the product manual from the non-transitory computer-readable medium when the authentication period has expired.

12. The system of claim 11, further comprising the server, wherein the server stores a plurality of product manuals, including the product manual, metadata associated with each of the plurality of product manuals, and user settings.

13. The system of claim 12, wherein the metadata associated with each of the plurality of product manuals specifies a mining product associated with each of the plurality of product manuals.

14. The system of claim 13, wherein the user settings associated with the user specify at least one mining product associated with the user, and wherein the electronic device is configured to download the product manual by matching the at least one mining product to the mining product associated with each of the plurality of product manuals.

15. The system of claim 11, wherein the authentication period is associated with each product manual downloaded to the computer-readable medium by the user.

16. The system of claim 11, wherein the device is further configured to display an alert to the user when the authentication period has expired.

17. The system of claim 11, wherein the device is configured to automatically delete the product manual by
setting an extension period after the authentication period has expired, the extension period running from a first verification of user credentials after the authentication period has expired to a predetermined period of time after the first verification; and
automatically deleting the product manual from the non-transitory computer-readable medium when no request to perform device authentication from the user is received during the extension period.

18. The system of claim 11, wherein the device is further configured to:
receive a request to perform device authentication from the user before the authentication period expires;
in response to the request to perform device authentication, connect to the at least one server; and
reset the authentication period.

19. The system of claim 16, wherein the device is configured to, in response to the request to perform device authentication, download an updated version of the product manual from the at least one server.

20. Non-transitory computer-readable medium containing executable instructions for:
downloading a product manual over at least one network;
storing the product manual to non-transitory computer-readable medium;
associating an authentication period with the product manual;
receiving a request to display the product manual from a user;
in response to the request, displaying the product manual to the user when the authentication period has not expired; and
automatically deleting the product manual from the non-transitory computer-readable medium when the authentication period has expired.
